(19) United States
(12) Patent Application Publication
(10) Pub. No.: US 2002/0116260 A1
(43) Pub. Date: Aug. 22, 2002

(54) Method and apparatus for stimulating commerce

(75) Inventors: Robert M. Szabo, Boca Raton, FL (US); James J. Toohey, Boca Raton, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/785,700

(22) Filed: Feb. 16, 2001

(51) Int. Cl. G06F 17/60

(52) U.S. Cl. 705/14; 705/10

(57) ABSTRACT

A method and a system for providing promotional material to consumers can include a series of steps. The steps can include establishing a computer communications session between a merchant computer system and a remote computer system and reading consumer purchase information from the merchant computer system. The consumer purchase information can include consumer identifying information and product information. The step of identifying one or more consumers in need of one or more products based on the consumer purchase information can be included. The method further can include the step of associating the promotional material corresponding to the one or more products with the identified consumers in the remote computer system. Additionally, the step of making the promotional material available to the identified consumers using a promotional material delivery system can be included.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

This invention relates to the field of information management, and more particularly, to incorporating information management in advertising for stimulating commerce.

2. Description of the Related Art

Advertising can be an important aspect of any successful business. Differing methods of advertising are continually devised in an effort to appeal to consumers and to entice those consumers into visiting a merchant's store. One particularly effective and popular method of advertising can be mass marketing. Mass marketing is a method of advertising intended to attract the interest of vast numbers of consumers. Mass marketing is able to reach large numbers of consumers by using various delivery methods, such as newspapers, mass mailings, and electronic mail to deliver promotional material efficiently to the consumer. For example, merchants can distribute promotional material, such as a coupon or an invitation to visit the merchant's store, through the mail or within an ad in a newspaper. In this manner, consumers can become more aware of what a particular merchant has to offer. Notably, advertising, and especially mass marketing, can be equally as important with regard to on-line merchants, as well as off-line merchants, commonly referred to as “brick and mortar” merchants.

Though advertising can be important to both on-line merchants and off-line merchants, it has been on-line commerce systems that have taken advertising into new directions. For example, on-line commerce systems enable the merchant to provide individually tailored incentives to consumers on a mass marketing level. Conventional on-line commerce systems can use several types of information to design effective advertising campaigns. One such type of information can be demographic information. On-line commerce systems often can use demographic information to determine a set of likely consumer preferences. For example, if a merchant's consumer base is comprised of young males, and demographic data suggests that young males like sports cars, and particularly sports cars within a specific price range, then the on-line commerce system can provide that demographic group of consumers with such promotional material.

Another type of information used by on-line commerce systems can be personal consumer information. This information is provided directly from the consumer. For example, a consumer can fill out a survey form indicating the consumer's preference for particular goods and services, as well as information relating to the consumer's buying habits and income. An on-line commerce system can analyze this information in an effort to provide the consumer with advertising corresponding to goods likely to be desired by that consumer. Common examples of this technology can be web sites requiring a consumer to log in to the web site. Typically, a consumer has provided personal information to acquire a user name and a password. Thus, after logging in to the web site, the web site can dynamically determine and display advertising corresponding to the consumer's preferences.

Another type of information used by on-line commerce systems can be past consumer purchasing behavior. This advertising technique is referred to as data mining. Through collection of past consumer purchase information, merchants can provide promotional material relating to products or services which consumers have purchased from the merchant in the past.

Although conventional on-line commerce systems and traditional mass marketing techniques can increase consumer demand for products, such systems can be limited with regard to the manner in which promotional material is provided to consumers. For example, conventional commerce systems, both on-line and off-line, can be limited to targeting consumers having a stated or inferred preference for particular goods or services.

### SUMMARY OF THE INVENTION

The invention provides a method and a system for stimulating commerce. In particular, the invention can stimulate shopping among consumers. The invention involves tracking consumer purchase information containing consumer identifying information and product information. The invention can determine from the consumer purchase information which consumers are in need of replacement products or product upgrades. Notably, products can include goods, services, or a combination of both. The invention can associate promotional material corresponding to the products needing replacement or upgrade with the identified consumers. The associated promotional material can be made available to the identified consumers through one or more delivery systems.

The inventive method taught herein can begin by establishing a computer communications session between a merchant computer system and a remote computer system and reading consumer purchase information from the merchant computer system. The consumer purchase information can include consumer identifying information and product information. Notably, the product information can include product expiration information and product identifying information. Based on the consumer purchase information, which can be read from a purchase history database, the method can include identifying one or more consumers in need of one or more products. The identifying step further can include determining a product consumption rate from the consumer purchase information to identify the one or more consumers in need of one or more products. The step of identifying one or more consumers can be responsive to a merchant request or detecting a business necessity in an inventory management system. Additionally, the one or more products can be goods, services, or both. Further the method can include associating the promotional material corresponding to the one or more products with the identified consumers in the remote computer system. The method also can include making the promotional material available to the identified consumers. The promotional material made available to the identified consumers can be in electronic or printed format.

Another aspect of the invention can be a system for providing promotional material to consumers. The system can include a consumer purchase information data structure for storing consumer identifying information and product information corresponding to a purchase transaction. Also included in the system can be a shopping stimulation logic unit for identifying one or more consumers in need of one or more products. The shopping stimulation logic unit also can identify a business necessity. A promotional information database, accessible by the shopping logic stimulation unit, for storing promotional information relating to the one or more products also can be included in the system.

The system of the invention can include a commerce system for collecting the consumer purchase information. Additionally, the system can include a point of sale system for collecting the consumer purchase information. The system also can include a merchant inventory management system for interfacing with the shopping stimulation logic unit. Finally, the system can include a delivery system for delivering promotional material associated with the one or more products to the one or more consumers.

Another aspect of the invention can be a machine readable storage, having stored thereon a computer program having a plurality of code sections executable by a machine for causing the machine to perform a series of steps. The steps can include establishing a computer communications session between a merchant computer system and a remote computer system and reading consumer purchase information from the merchant computer system. The consumer purchase information can include consumer identifying information and product information. The product information can include product expiration information and product identifying information. The step of identifying one or more consumers in need of one or more products based on the consumer purchase information can be included. The identifying step also can include determining a product consumption rate from the consumer purchase information to identify the one or more consumers in need of one or more products. Notably, the step of identifying one or more consumers can be responsive to a merchant request or detecting a business necessity in an inventory management system. Further, the one or more products can be goods, services, or both. Additionally, the step of associating promotional material corresponding to the one or more products with the identified consumers in the remote computer system can be included. The step of making the promotional material available to the identified consumers also can be included. The promotional material made available to the identified consumers can be in electronic or printed format.

### BRIEF DESCRIPTION OF THE DRAWINGS

There are shown in the drawings embodiments which are preferred, it being understood, however, that the invention is not so limited to the precise arrangements and instrumentalities shown, wherein:

FIG. 1 is a schematic diagram depicting an exemplary system for utilizing the method of the invention.

FIG. 2 is a schematic diagram of an exemplary commerce stimulating system in conjunction with exemplary merchant systems and delivery systems.

FIG. 3 is a schematic diagram of an exemplary network configuration capable of utilizing the method of the invention.

FIG. 4 is a flow chart illustrating a process for stimulating commerce among consumers.

### DETAILED DESCRIPTION OF THE INVENTION

The invention concerns a method and system for stimulating commerce. In particular, the invention concerns stimulating shopping among consumers. The invention disclosed herein can enable merchants to identify consumers in need of particular products, rather than identifying consumers having only a preference or an inferred preference for a product in general. Further, the invention enables promotional material associated with the particular products to be made available to the identified consumers. The term product, as used herein, can refer to a good, or a service, or combination of the two.

The invention can read and process consumer purchase information which includes product information and consumer identifying information to identify one or more consumers likely to be in need of a replacement product, a new product, or an upgraded product. Moreover, the invention can identify such consumers based upon a merchant request or in the event of a business necessity, such as a merchant having excess inventory, a merchant experiencing a revenue shortfall, a merchant receiving a shipment of goods, or a merchant offering a new or enhanced product or service. Accordingly, promotional material can be made available to one or more identified consumers all relating to the product needed by the consumer. Promotional material can include print formatted promotional material such as conventional paper coupons, general advertising, and other printed advertisements, as well as electronically formatted promotional materials such as telephonic promotional materials (i.e., recordings), electronic coupons, shopper points, shopping list builders, electronic solicitations and electronic mails, and other specials or consumer enticements.

The invention disclosed herein can be implemented in an on-line environment, such as the Internet or other computer communications network. Additionally, the invention can be utilized by on-line, as well as off-line, merchants. The invention also can be operably connected to a merchant inventory management system such that the invention can respond automatically to any of the aforementioned business necessities as determined by the invention from information contained within the inventory management system and purchase history database.

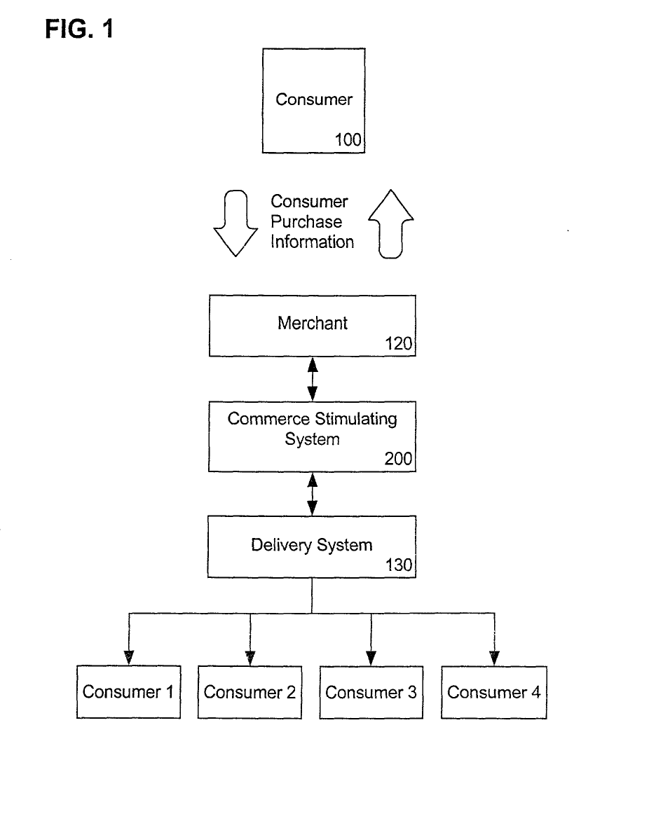

FIG. 1 is a schematic diagram depicting an exemplary system containing a consumer 100, a merchant 120, a Commerce Stimulating System (CSS) 200, and a delivery system 130. The consumer 100 can visit merchant 120 to initiate a transaction for purchasing a product, which can be a good or a service. Merchant 120 can be located in a conventional off-line storefront which the consumer 100 can visit in person. Alternatively, merchant 120 can be an on-line storefront which the consumer 100 can visit through the Internet or other computer communications network. For example, consumer 100 can visit a commercial website operated by merchant 120 for selling products.

Consumer 100 can purchase a product from the merchant 120. At some point before, during, or after the transaction, the merchant 120 can collect consumer purchase information. Consumer purchase information can include consumer identifying information for uniquely identifying consumer 100 and product information. For example, consumer identifying information can be a name, a physical mailing address, an electronic mail address, a telephone number, a user name, a password, and other personal information such as product preference information or demographic information. Consumer purchase information can be collected electronically or manually. For example, in a “brick and mortar” environment, the consumer can fill out a paper form to be entered into a merchant point of sale system at a later time by a merchant employee. Alternatively, the consumer 100 can fill out an electronic form at a computer provided in the merchant 120 storefront. The information also can be collected automatically from a card reader when a consumer uses a debit or credit card to purchase products. In an on-line environment, consumer identifying information can be collected, for example, by asking the user to provide such information by entering data within a form on a web site. In subsequent transactions, the consumer identifying information can be recalled automatically.

Product information can include product identifying information as well as product expiration information. Product identifying information can uniquely identify a particular product being purchased by a consumer. Product expiration information can correspond to a product's estimated useful life. This information can relate to the length of time ordinarily associated with a product to fail or otherwise become obsolete. For example, food can have an expiration date. Accordingly, product expiration information can correspond to a product's “sell by date” or some period of time after the “sell by date”. Product expiration information also can correspond to the life cycle of a product, which typically does not wear out, but rather becomes obsolete or otherwise undesirable. Examples of such products can include fashion related products and computer software. For example, though trendy clothing may not wear out, a consumer of such clothing may not wish to wear last season's fashions. Accordingly, the product expiration information for high fashion garments can indicate a useful life of several months. In the case of software, product expiration information can indicate a useful life of several months to several years.

In a conventional “brick and mortar” business, product information can be contained within a manufacturer provided universal product code (UPC), a stock keeping unit (SKU) number, a retailer code, or other identifier which can be in either human readable or machine readable form. In the case where such information is not included in a manufacturer provided code, the information can be provided by the merchant in a merchant product identifier. In an on-line environment, product information can be programmed in a website such that the information can be collected upon a user clicking on an icon representing a product. Alternatively, in the case of perishable goods or other goods with a limited shelf life, product information can be provided at the time the product is shipped. Regardless of how the product information is collected by the merchant 120, the product information can be provided to the CSS 200 via a computer communications link between merchant equipment and the CSS 200.

The CSS 200 can be operatively connected to merchant 120 systems such as an inventory management system, a point of sale system, a commerce system, and a purchase history database. The CSS 200 can read consumer purchase information from merchant systems for subsequently identifying consumers in need of particular products. Additionally, CSS 200 can store promotional material corresponding to the inventory of merchant 120. Thus, the CSS 200 can associate promotional material of the merchant 120 products with consumers identified as being in need of those products as indicated by the consumer purchase information. Although the CSS 200 is depicted as being a separate element from the merchant 120, and can be located at a location remote from the merchant 120, the CSS 200 also can be located on the premises of merchant 120. Notably, CSS 200 can interact with one or more merchants, and accordingly, can contain promotional materials for those multiple merchants. In any case, CSS 200 can be operatively connected to merchant equipment via a computer communications link or via the Internet to read consumer information and provide promotional material to the delivery system 130.

Delivery system 130 can receive promotional material corresponding consumer purchase information from the CSS 200 for delivery to consumers. Notably, the consumer purchase information can identify a consumer and the manner in which the promotional material can be delivered to the consumer. For example, promotional material can be provided by regular mail, electronic mail, telephone communications, or by the consumer logging on to a Internet web site. Thus, the delivery system can provide consumers identified by received consumer purchase information with the promotional material corresponding to the products for which those consumers were identified as having a need. Delivery system 130 can be implemented within CSS 200, or alternatively, as a separate system. Further, delivery system 130 can be comprised of several individual delivery systems. For example, delivery system 130 can be an electronic delivery system such as a shopping list builder, an electronic coupon delivery system, an e-solicitation system, or a telephonic delivery system. Notably, these delivery systems can deliver electronically formatted promotional material. Alternatively, the delivery system can be a conventional delivery system such as the distribution of advertising or other incentives through newspapers or direct mail. These delivery systems can deliver printed promotional materials. It should be appreciated that the CSS 200 can filter or mask consumer purchase information such that only the consumer data necessary for a delivery system to accurately deliver promotional materials to consumers can be provided. For example, if an electronic delivery system only needs an electronic mail address for delivery, the CSS 200 can mask all information other than the consumer's electronic mail address and optionally the consumer's name. Thus, the CSS 200 can provide the electronic delivery system with only the consumer's electronic mail address, an optional consumer name, and promotional material associated with that consumer. Regardless of how delivery system 130 is implemented, it can be operatively connected to the CSS 200 such that promotional material supplied from CSS 200 can be provided to consumers identified as needing the products to which the promotional material is directed.

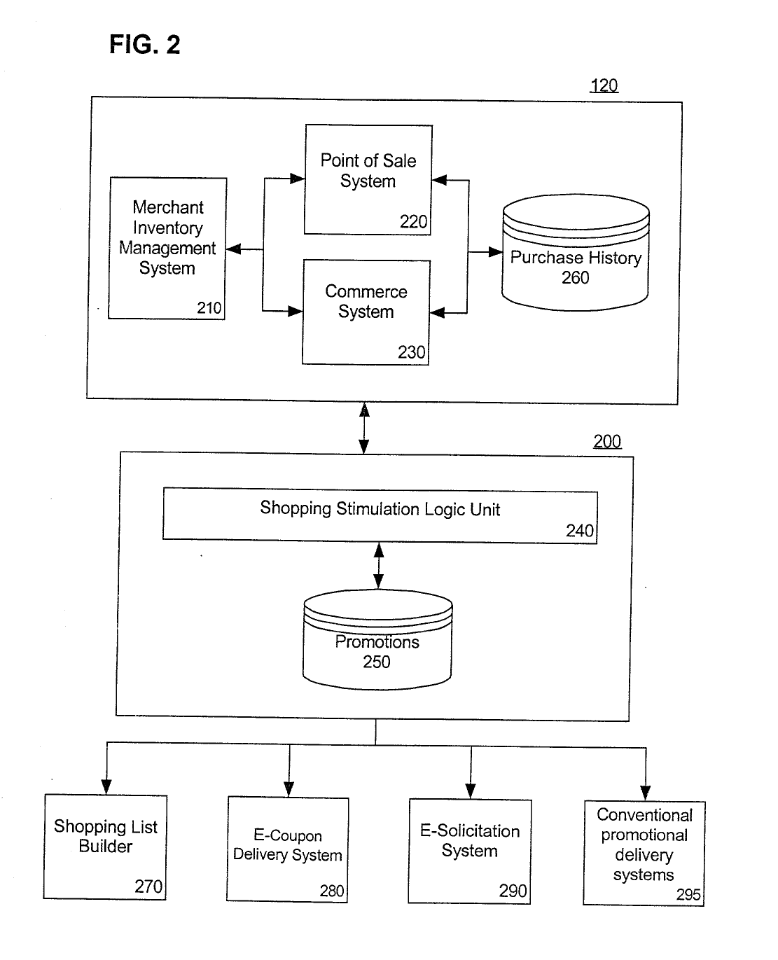

A CSS 200 in accordance with the inventive arrangements is shown in FIG. 2 in conjunction with exemplary merchant systems and delivery systems. The merchant systems depicted in FIG. 2 include a merchant inventory system 210, a point of sale system 220, a commerce system 230, and a purchase history database 260. The merchant inventory management system 210, located on the merchant's premises, can be any inventory management system capable of sharing information with other systems through a computer communications link. Notably, the merchant inventory management system can contain any information necessary for the merchant to track product inventory as products are received and sold. For example, the inventory management system 210 can include information regarding incoming shipments of products, the number of units sold or returned and any other relevant data for tracking inventory. Notably, merchant inventory management system 210 can contain product information. As mentioned, product information can be provided by the manufacturer and possibly downloaded from a manufacturer website for example. Alternatively, product information can be determined by the merchant and entered by the merchant.

The point of sale system 220, located on the merchant's premises, can process purchase transactions conducted in a face to face manner. For example, the point of sale system 220 can include the hardware and software necessary to identify a product, display a total price for products being purchased, collect money from a consumer, and interface with the merchant's inventory management system 210 and the purchase history database 260. The point of sale system also can be used to collect consumer purchase information. For example, consumer identifying information can be collected by the point of sale system 220 by a card reader, recalled from a database, or entered manually into the point of sale system 220 by a clerk as provided by the consumer.

Product information can be read by the point of sale system 220 from machine readable code affixed upon the product such as a bar code containing UPC information. Additionally, a product identifier can be manually entered into the point of sale system 220 by a merchant employee. If the product information does not exist within a merchant system, the clerk can manually enter product information into the point of sale system. The point of sale system 220 can communicate with the merchant inventory management system 210 to adjust inventory information according to the consumer purchase information relating to the products sold. Also, the point of sale system 220 can store the consumer information within the consumer purchase history database 260.

Similar to point of sale system 220, commerce system 230 can process transactions and collect consumer purchase information. Notably, commerce system 230 can process transactions conducted over the Internet or other computer communications network rather than face to face transactions. For example, commerce system 230 can be implemented as an Internet web site where a consumer can select a product and provide consumer identifying information. If the consumer has previously initiated a transaction with the merchant, consumer identifying information can be recalled from the previous transaction. The commerce system 230 can process the transaction, for example a credit card transaction, and collect the consumer purchase information. Subsequently, the commerce system 230 can communicate with the merchant inventory management system 210 for adjusting inventory information according to the consumer information relating to the products sold. Also, the commerce system 230 can store consumer information within the purchase history database 260.

A purchase history database can store consumer purchase information collected from the commerce system 230 and the point of sale system 220 for each product sold by the merchant. For example, each purchase made by a consumer at a merchant's business establishment can be recorded. Thus, the purchase history database can contain product information and associated consumer identifying information such that the consumer and the product purchased by that consumer can be identified. Further, the product expiration information, as well as the purchase date, can be stored in the purchase history database 230.

The CSS 200, as shown in FIG. 2, can include a shopping stimulation logic unit (SSLU) 240 and a promotions database 250. The CSS 200 can be implemented as one or more application programs contained in a conventional computer system such as an Internet web server or other commercially available high speed computer system operably connected to the aforementioned merchant systems through a computer communications network or the Internet. For example, the SSLU 240 can read information from the inventory management system 210 and the purchase history database 260. Based on consumer purchase information stored within the purchase history database 260, the SSLU 240 can identify consumers in need of products. The SSLU 240 further can read the merchant inventory management system 210 to determine whether a business necessity exists for identifying consumers in need of particular products. Examples of business necessities can include the merchant having excess inventory, the merchant experiencing a revenue shortfall, the merchant receiving a shipment of goods, or the merchant offering a new service. Notably, the SSLU 240 can be responsive to a merchant request for consumers to be provided with promotional material. Alternatively, the SSLU 240 can continually access the merchant systems to determine consumers needing particular products or to determine business necessities.

The promotions database 250 can contain the promotional material corresponding to a particular merchant. For example, the promotions database 250 can include any promotional material corresponding to the products offered for sale by the particular merchant. Further the promotions database 250 can contain promotional material corresponding to a plurality of merchants. In that case the promotions database 250 can be implemented as one or more databases. Upon identifying one or more consumers in need of one or more particular products, the SSLU 240 can access the promotions database 250 to associate promotional materials relating to those products with the identified consumers. Additionally, the SSLU 240 need not access only promotional material for the exact product needed by the consumer, but rather can access promotional materials for equivalent, similar, or related products corresponding to the products needed by the identified consumers.

It should be appreciated that the CSS can allow a merchant to access the promotions database to regulate and edit the promotional material offered to consumers. For example, the merchant can determine the content of the promotional material for the products for which promotional material will be offered, the duration in which particular promotions will be offered, and whether the promotional material will include discounts. Notably the merchant can regulate the promotional material on a product by product basis.

The exemplary delivery services as shown in FIG. 2 can include a shopping builder list 270, an electronic coupon delivery system 280, an electronic solicitation system 290, and a conventional delivery system 295. It should be appreciated that the invention is not so limited to the examples disclosed and can include any of a variety of conventional, as well as electronic, systems for delivering promotional material to consumers. For example, a conventional delivery system can include any method of delivering printed promotional materials such as newspaper advertising, hand delivery of promotional material, and delivery of promotional material through the postal service. Electronic delivery systems can include telephonic promotional systems, systems utilizing electronic mail, or the Internet in the form of a web page. One or more delivery services can be included within the CSS 200, or alternatively, can be implemented as one or more separate services.

The shopping list builder 270 can receive consumer purchase information and associated promotional material for displaying promotional material on a web page which can be tailored to a particular consumer. The consumer can log on to the web page to view the promotional material which is tailored to that consumer. Similarly, the electronic coupon delivery system 280 can deliver electronic coupons in accordance with received consumer purchase information and promotional information. The electronic solicitation system 290, as is described in U.S. Pat. No. 6,101,485, can deliver electronic solicitations to consumers in accordance with received consumer purchase information and promotional information.

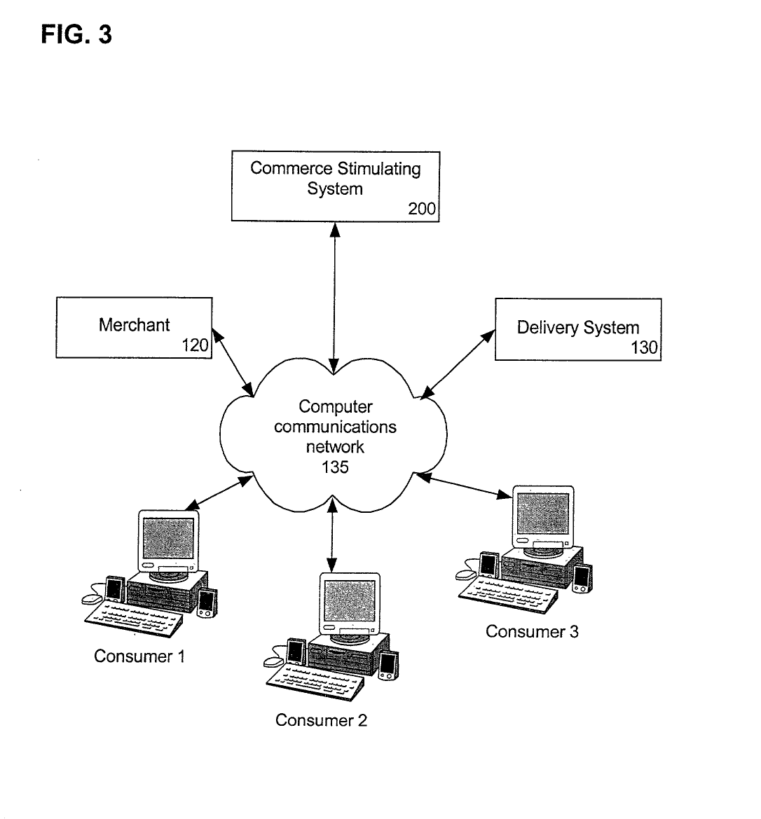

FIG. 3 is a schematic diagram illustrating one embodiment of the invention where the CSS 200, the merchant 120, and the delivery system 130 can be interconnected using a computer communications network 135. Notably, communication can be facilitated through any suitable computer communications network. For example, the computer communications network 135 can be the Internet where communication can be facilitated using TCP/IP, HTTP, and FTP protocols, each well known in the art. Alternatively, communication can be facilitated through direct network access, a local area network, a wide area network, an Integrated Service Digital Network (ISDN) connection, or a series of direct dial up connections initiated by the merchant's computer systems or the CSS 200. Any suitable method of connecting computers in a computer communications network can be used as well as any suitable network protocol for information exchange such as electronic data interchange (EDI) as is commonly used in business applications.

As shown in FIG. 3, delivery system 130 can receive promotional materials via the computer communications network 135 and further deliver those promotional materials to consumers through the network in electronic format. It should be appreciated, however, that the delivery system 130 also can utilize traditional delivery methods such as newspaper advertising and the mails. Specifically, the delivery system 130 can receive electronically formatted promotional materials from the CSS 200 via the computer communications network 135, process those materials and distribute them to consumers via the network 135 in electronic format, or using other distribution methods for delivery of promotional materials in printed form.

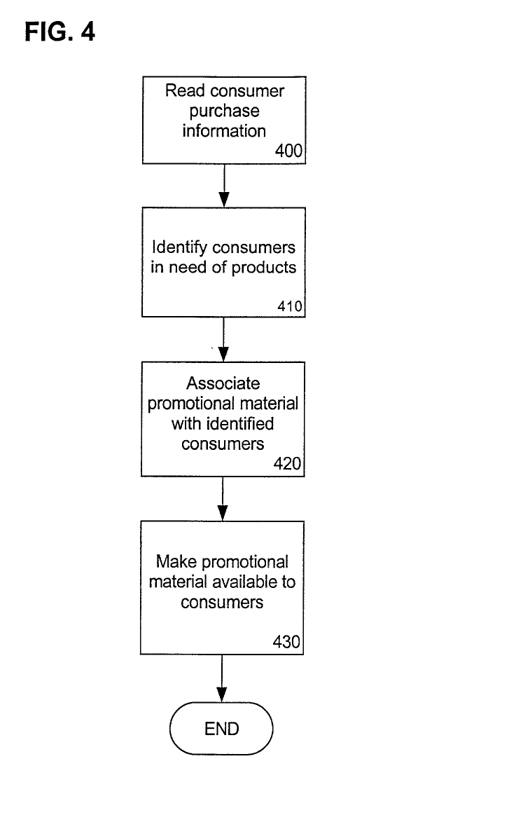

FIG. 4 is a flow chart illustrating a process for stimulating commerce among consumers as performed by the CSS 200 of FIG. 2. The CSS begins in a normal operating condition. Accordingly, at the outset of the process of FIG. 4, it is presumed that the CSS has received a merchant request for consumers to be provided with promotional material.

For example, the merchant can have excess inventory or require warehouse space to accommodate a new shipment of product. Accordingly, the merchant can request that the CSS identify consumers in an effort to sell product to those consumers thereby making space for new product shipments. Alternatively, the CSS automatically can be responding to an identified business necessity as determined by accessing the merchant inventory management system and purchase history database. For example, the CSS can determine statistical norms of inventory levels from the merchant's inventory management system. Thus, deviation from those established norms can cause the CSS to respond by identifying consumers likely to purchase or needing the excess product. Another embodiment can allow the merchant to provide the CSS with inventory parameters or guidelines specifying acceptable amounts of inventory at particular times of the year. Notably, the merchant can log on to the CSS to administer those parameters. For example, the merchant can log on to the CSS via the Internet or through a dial up connection. Still, the exemplary process of FIG. 4 can be performed automatically by the CSS such that consumers can be provided with promotional material upon identifying consumers having a need for a particular product from the purchase history database.

Regardless of how the exemplary process of FIG. 4 is initiated, a method of the invention can begin at step 400. In step 400 the CSS can access and read consumer purchase information from a purchase history database containing consumer purchase information. After completion of step 400, the CSS can proceed to step 410.

In step 410, the CSS can identify consumers in need of one or more products being offered for sale by a merchant. Specifically, the CSS can read product expiration information from the purchase history database to determine which products are likely to expire or have expired based upon the product expiration date and the current date. The CSS can identify the consumers having purchased those products from the corresponding consumer identifying information.

The CSS also can track the purchase history of a consumer relating to one or more products to determine product consumption rate information. Product consumption rate information can be the elapsed time between consecutive purchases of equivalent, similar, or related products from a single merchant or merchant entity as calculated from the consumer information within the purchase history database. Although a product may not have expired, the CSS can determine that a consumer may need a replacement, upgrade, or other equivalent or similar product. For example, though a computer may not be considered obsolete for three years after its purchase, the CSS can determine that a particular consumer buys a new computer every two years. Thus, the CSS can identify that particular consumer as being in need of a replacement, upgrade, or other equivalent product two years after the purchase of a computer. This technique can be useful in cases where a consumer will likely need a replacement product prior to the products expiration date. For example, if the product is shampoo, the consumer will likely need a replacement within a time period of several months even though the shampoo can have a shelf life of several years.

As mentioned, the CSS can identify consumers in response to a merchant request to do so. For example, the merchant may need additional space for incoming shipments of inventory, or alternatively, may need to sell product, such as bread, which is about to expire. Thus, the merchant can request that the CSS identify one or more consumers in need of bread. Consequently, the CSS can identify consumers from the purchase history database whose consumer information indicates that bread previously bought from the merchant will expire. Alternatively, the CSS can identify consumers having purchased bread which is not yet expired, but who typically purchase bread on a weekly basis, and accordingly, are in need of bread.

Taking another example, printer toner cartridges are typically rated for printing a predetermined number of pages. If the merchant requests that the CSS identify consumers in need of toner cartridges because the toner cartridges in stock are nearing expiration, the CSS can examine the purchase history database to identify consumers who previously have bought that particular product. Accordingly, based upon the purchase dates, the CSS can infer the number of pages per month, or other time period, which that consumer prints using toner cartridges such that the CSS can determine whether that consumer is likely to be in need of toner cartridges. Notably, the calculation can be performed with reference to the consumer's last date of purchase of toner cartridges. After completion of step 410, the CSS can proceed to step 420.

In step 420, the CSS can associate promotional materials with one or more identified consumers. The promotional material can correspond to products purchased by the consumer and identified as being in need of replacement or replenishing. For example, if a consumer was identified as being in need of bread, the CSS can locate promotional material from the promotions database corresponding to bread. Notably, the promotional material can be informative, in that the promotional material can merely inform the user of the availability of new models, competitive prices, or the level of quality available from a merchant. The promotional material also can offer the consumer a discount or other incentive for purchasing a product from the merchant. Other forms of promotional material can include materials for upgrading or “upselling” the consumer a higher quality or more expensive product. After completion of step 420, the CSS can proceed to step 430.

In step 430, the CSS can make any associated promotional material available to the identified consumers. As mentioned, the CSS can provide the promotional material and consumer purchase information to a third party to perform delivery services. Alternatively, promotional delivery services can be included within the CSS. Regardless, consumers can be provided with promotional materials corresponding to products for which the consumers have a need. Additionally, the promotional materials can be provided to consumers using any of the aforementioned methods, including electronic and more conventional methods of mass marketing.

The present invention can be realized in hardware, software, or a combination of hardware and software. A method and system for stimulating commerce according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A method of providing promotional material to consumers comprising:
establishing a computer communications session between a merchant computer system and a remote computer system;
reading consumer purchase information from said merchant computer system, said consumer purchase information comprising consumer identifying information and product information;
based on said consumer purchase information, identifying one or more consumers in need of one or more products;
in said remote computer system, associating said promotional material corresponding to said one or more products with said identified consumers; and
making said promotional material available to said identified consumers using a promotional material delivery system.

2. The method of claim 1, said identifying step further comprising determining a product consumption rate from said consumer purchase information to identify said one or more consumers in need of one or more products.

3. The method of claim 1, wherein said step of reading consumer purchase information is responsive to a merchant request.

4. The method of claim 1, wherein said step of reading consumer purchase information is responsive to detecting a business necessity in an inventory management system.

5. The method of claim 1, wherein said consumer purchase information is read from a purchase history database.

6. The method of claim 1, wherein said one or more products include goods or services or both.

7. The method of claim 1, said product information comprising product expiration information and product identifying information.

8. The method of claim 1, wherein said promotional material made available to said identified consumers is in electronic format.

9. The method of claim 1, wherein said promotional material made available to said identified consumers is in printed format.

10. A system for providing promotional material to consumers comprising:
a shopping stimulation logic unit for identifying one or more consumers in need of one or more products, and for identifying a business necessity; and,
a promotional information database, accessible by said shopping stimulation logic unit, for storing promotional information relating to said one or more products.

11. The system of claim 10, further comprising:
a consumer purchase information data structure for storing consumer identifying information and product information corresponding to a purchase transaction.

12. The system of claim 10, further comprising:
a commerce system for collecting said consumer purchase information in a computer communications network environment.

13. The system of claim 10, further comprising:
a point of sale system for collecting said consumer purchase information.

14. The system of claim 10, further comprising:
a merchant inventory management system for interfacing with said shopping stimulation logic unit.

15. The system of claim 10, further comprising:
a delivery system for delivering promotional material associated with said one or more products to said one or more consumers.

16. A machine readable storage, having stored thereon a computer program having a plurality of code sections executable by a machine for causing the machine to perform the steps of:
establishing a computer communications session between a merchant computer system and a remote computer system;
reading consumer purchase information from said merchant computer system, said consumer purchase information comprising consumer identifying information and product information;
based on said consumer purchase information, identifying one or more consumers in need of one or more products;
in said remote computer system, associating said promotional material corresponding to said one or more products with said identified consumers; and
making said promotional material available to said identified consumers using a promotional material delivery system.

17. The machine readable storage of claim 16, said identifying step further comprising determining a product consumption rate from said consumer purchase information to identify said one or more consumers in need of one or more products.

18. The machine readable storage of claim 16, wherein said step of reading consumer purchase information is responsive to a merchant request.

19. The machine readable storage of claim 16, wherein said step of reading consumer purchase information is responsive to detecting a business necessity in an inventory management system.

20. The machine readable storage of claim 16, wherein said consumer purchase information is read from a purchase history database.

21. The machine readable storage of claim 16, wherein said one or more products include goods or services or both.

22. The machine readable storage of claim 16, said product information comprising product expiration information and product identifying information.

23. The machine readable storage of claim 16, wherein said promotional material made available to said identified consumers is in electronic format.

24. The machine readable storage of claim 16, wherein said promotional material made available to said identified consumers is in printed format.
